(19) United States
(12) Patent Application Publication
(10) Pub. No.: US 2026/0109042 A1
(43) Pub. Date: Apr. 23, 2026

(54) LASER WELDING TOOL AND LASER WELDING SYSTEM INCLUDING THE SAME

(71) Applicants: Hyundai Motor Company, Seoul (KR); Kia Corporation, Seoul (KR); HBL Corporation, Daejeon (KR)

(72) Inventors: Tae Heun JIN, Gyeonggi-do (KR); Jong Chol SEO, Gyeonggi-do (KR); Hui Chan JEON, Gyeonggi-do (KR); Min Sun SIM, Gyeonggi-do (KR); Byeong Gi YOO, Gyeonggi-do (KR); Min Gyu HONG, Daejeon (KR)

(21) Appl. No.: 19/362,818

(22) Filed: Oct. 20, 2025

(30) Foreign Application Priority Data
Oct. 18, 2024 (KR) 10-2024-0143277
Jul. 8, 2025 (KR) 10-2025-0091521

(51) Int. Cl. B25J 9/16; B23K 26/044; B23K 26/08; B23K 37/02; B25J 11/00; B25J 15/00; B25J 17/02; B25J 19/00

(52) U.S. Cl. CPC B25J 9/1684; B23K 26/044; B23K 26/0876; B23K 37/0229; B25J 11/005; B25J 15/0019; B25J 17/0225; B25J 19/0004

(57) ABSTRACT

A laser welding tool including a welding head, a welding tip mounted to the welding head, a guide pin disposed so as to be spaced apart from the welding tip, a support device that supports the welding head and the guide pin, and a floating apparatus connected to the support device and configured to allow the welding head and the guide pin on the support device move in a floating state, relative to the floating apparatus, along an up-and-down direction and along a right-and-left direction while the guide pin is in a state of contacting a welding target portion during welding.

### CROSS-REFERENCE TO RELATED APPLICATION

Pursuant to 35 U.S.C. § 119(a), this application claims the benefit of an earlier filing date and right of priority to Korean Patent Application No. 10-2024-0143277 filed on Oct. 18, 2024, the entire contents of which are incorporated herein by reference.

### TECHNICAL FIELD

The present disclosure relates to a laser welding system equipped with a contact-type guide pin for seam tracking.

### BACKGROUND

Generally, a panel member having a gently curved surface shape, such as a hood panel or a door panel of a vehicle, is composed of an outer panel on the surface side and an inner panel on the rear side configured to reinforce the outer panel.

In such panel members, the two panels are joined by a hemming process, in which a flange formed along the edge portion of the outer panel is bent to cover the edge portion of the inner panel.

Based on the outer panel and the inner panel being joined to each other through the hemming process, a hemming seal is applied along the edge portions of the two panels, and the panels are placed in a temporary assembled state onto a hemming die, after which the hemming process is carried out. In this process, the flange of the outer panel is bent and folded over the edge portion of the inner panel using a hemming device, thus joining the two panels together.

In an assembly process of a vehicle body for manufacturing a body-in-white (BIW), the hemming process, which joins the panels by folding them as described above, is widely used as a method for joining panels.

FIG. 1 is a cross-sectional view illustrating a hemming portion in a state where the outer panel and the inner panel are joined to each other. In conventional processes, an operation of pre-curing the hemming seal was required. The illustrated example may be the cross-section of the hemming portion of a hood panel in which the edge portion of the outer panel and the edge portion of the inner panel are joined to each other by a hemming process.

As illustrated in the drawing, a hemming seal 3 is applied between the edge portion of the outer panel 1 and the edge portion of the inner panel 2 prior to the hemming process, and the painting seal 5 is applied to the flange 1a and the edge portion 1b of the outer panel 1 and the inner surface of the inner panel 2 in a painting process after assembly of the vehicle body.

The hemming seal 3 and the painting seal 5 are applied along the edge portions of the outer panel 1 and the inner panel 2. In order to prevent movement of the two panels joined to each other after the liquid-phase hemming seal 3 is applied between the two panels 1 and 2, a pre-curing process is performed in which the hemming sealer 3 is cured only to a certain degree, not to completion.

Here, a method such as induction heating or the like is used in pre-curing of the hemming seal 3. In the method, the two panels 1 and 2, which are joined to each other with the hemming seal applied thereto, are loaded to a jig, and hemming seal 3 is pre-cured using induction heating units (not shown) which are disposed along the edge portions of the two panels 1 and 2.

The pre-cured hemming seal 3 is subsequently electrodeposited in a painting process, and is completely cured together with the painting seal 5 while passing through an oven. In a conventional pre-curing process, the jig (not shown) to which the two panels 1 and 2 are loaded and a plurality of induction heating units are disposed at plural positions set along the edge portions of the two panels 1 and 2.

In the related art, a process of pre-curing the hemming seal using a plurality of induction heating units was required, resulting in problems such as increased cost and time due to the implementation of the pre-curing process and the use of the jigs.

The above information disclosed in this Background section is only for enhancement of understanding of the background of the present disclosure and therefore it may contain information that does not form the prior art that is already known in this country to a person of ordinary skill in the art.

### SUMMARY

In one aspect of the present disclosure, a laser welding tool includes a welding head, a welding tip mounted to the welding head, a guide pin disposed so as to be spaced apart from the welding tip, a support device that supports the welding head and the guide pin, and a floating apparatus configured to cause the support device to enter a floating state in which the support device is movable in an up-and-down direction and in a right-and-left direction while the guide pin moves in a state of contacting a welding target portion during welding.

Here, the welding tip may follow behind the guide pin along the welding target portion while the guide pin moves in the floating state of the support device.

In some implementations of the present disclosure, the welding target portion may include an edge portion of an end of a first panel and a surface portion of a second panel, the first panel and the second panel being welded to each other, and a front end of the guide pin may be guided along the edge portion without escaping from the edge portion by catching force applied to the edge portion while maintaining a state of contacting and pressing the edge portion of the first panel.

In some implementations of the present disclosure, the floating apparatus may include a first floating unit configured to float the support device to enable up-and-down movement of the support device while providing force required for the guide pin to press the welding target portion during welding, and a second floating unit configured to float the support device to enable right-and-left movement of the support device so as to apply an opposing force to the welding target portion during welding.

In some implementations of the present disclosure, the first floating unit may include a first support frame coupled to the second floating unit, and an elastic member disposed between the first support frame and the support device so as to elastically support the support device in the up-and-down direction.

In some implementations of the present disclosure, the first floating unit may further include a linear guide disposed between the first support frame and the support device so as to guide the support device, which is elastically moved by the elastic member, in the up-and-down direction.

In some implementations of the present disclosure, the second floating unit may include a second support frame, and a rotation device disposed between the second support frame and the first floating unit so as to rotate the first floating unit in the right-and-left direction with respect to the second support frame during welding such that the guide pin is brought into close contact with the welding target portion and provides the welding target portion with the opposing force.

In some implementations of the present disclosure, the rotation device may include a rotating actuator coupled to the second support frame, a rotating shaft of the rotating actuator being coupled to the first floating unit so as to swingably rotate the first floating unit in the right-and-left direction.

In some implementations of the present disclosure, the rotating actuator may be a pneumatic rotating cylinder or a hydraulic rotating cylinder.

Another aspect of the present disclosure provides a laser welding system including a laser welding tool including a welding head, a welding tip mounted to the welding head, a guide pin disposed so as to be spaced apart from the welding tip, a support device that supports the welding head and the guide pin, and a floating apparatus configured to cause the support device to enter a floating state in which the support device is movable in an up-and-down direction and in a right-and-left direction while the guide pin moves in a state of contacting a welding target portion during welding, a drive device configured to move the laser welding tool coupled to the drive device, and a controller configured to control operation of the drive device and the laser welding tool, wherein, while the laser welding tool is moved by the drive device during welding, the guide pin, which is supported in the floating state together with the welding head by the floating apparatus, is guided along the welding target portion in a state of contacting the welding target portion such that the laser welding tool tracks the welding target portion.

Here, a position and a posture of the laser welding tool may be controlled by operation of the drive device and the laser welding tool which are controlled by the controller such that the welding tip moves behind the guide pin along the welding target portion while the guide pin moves along the welding target portion.

In some implementations of the present disclosure, the floating apparatus may include a first floating unit configured to cause the support device to enter a floating state in which the support device is movable in the up-and-down direction while providing force required for the guide pin to press the welding target portion during welding, and a second floating unit configured to cause the support device to enter a floating state in which the support device is movable in the right-and-left direction so as to apply opposing force to the welding target portion during welding.

In some implementations of the present disclosure, the first floating unit may include a first support frame coupled to the second floating unit, and an elastic member disposed between the first support frame and the support device so as to elastically support the support device in the up-and-down direction.

In some implementations of the present disclosure, the first floating unit may further include a linear guide disposed between the first support frame and the support device so as to guide the support device, which is elastically moved by the elastic member, in the up-and-down direction.

In some implementations of the present disclosure, the first support frame may be provided with an upper limit bar, and the support device is provided with a stopper member, and the upper limit bar may limit upward movement of the support device by contact with the stopper member based on the support device being moved upwards to a limit height.

In some implementations of the present disclosure, the support device may be provided with an upper block, the first support frame may be provided with a lower block having a through hole, and the upper block may be provided with a guide rod which extends downwards and is inserted into the through hole in the lower block. The guide rod may move in an axial direction in a state of being inserted into the through hole while the support device moves in the up-and-down direction with respect to the first support frame, and the elastic member may be mounted to the guide rod between the upper block and the lower block.

In some implementations of the present disclosure, the first floating unit may further include a displacement sensor disposed between the first support frame and the support device so as to detect relative displacement of the support device with respect to the first support frame, and the controller may determine that the guide pin escapes from the welding target portion and performs control to stop operation of the drive device and the laser welding tool, based on a displacement value detected by the displacement sensor being out of a predetermined range

In some implementations of the present disclosure, the laser welding tool may include a second brake device controlled by the controller so as to lock the welding head at a predetermined position in the up-and-down direction and to release the locked state of the welding head, and the second brake device may include a friction member configured to be moved forwards to contact and press the support device to thus lock the support device such that the support device cannot be moved in the up-and-down direction and to be moved rearwards to be separated from the support device to thus release the locked state of the support device, and a drive actuator mounted to the first support frame and configured to move the friction member forwards and rearwards to thus lock the support device and release the locked state of the support device.

In some implementations of the present disclosure, the second floating unit may include a second support frame, and a rotation device disposed between the second support frame and the first floating unit so as to rotate the first floating unit in the right-and-left direction with respect to the second support frame such that the guide pin is brought into close contact with the welding target portion and provides opposing force to the welding target portion.

In some implementations of the present disclosure, the rotation device may include a rotating actuator coupled to the second support frame, a rotating shaft of the rotating actuator being coupled to the first floating unit so as to swingably rotate the first floating unit in the right-and-left direction, and the controller may perform control of force of the rotating actuator in order to control rotational directions and rotational positions of the support device and the welding head mounted to the support device.

In some implementations of the present disclosure, the rotation device may further include a rotation sensor connected to a rotating shaft to which the first floating unit is coupled and configured to detect rotating state of the rotating shaft, and the controller may determine that the guide pin escapes from the welding target portion and performs control to stop operation of the drive device and the laser welding tool, based on a rotational position detected by the rotation sensor being out of a predetermined range.

In some implementations of the present disclosure, the laser welding tool may include a normal position stopper controlled by the controller so as to lock the welding head at a normal reference position set in the right-and-left rotational direction and to release the locked state of the welding head, and the normal position stopper device may include a stopper configured to be moved forwards and be coupled to a locking groove formed in the first floating unit to thus lock the first floating unit such that the first floating unit cannot be rotated and to be moved rearwards and be separated from the locking groove in the first floating unit so as to release the locked state of the first floating unit, and a drive actuator mounted to the rotation device to move the stopper forwards and rearwards to thus lock the first floating unit and release the locked state of the first floating unit.

In some implementations of the present disclosure, the laser welding tool may include a first brake device controlled by the controlled so as to lock the welding head at a predetermined position in the right-and-left rotational direction and release the locked state of the welding head, and the first brake device may include a friction member configured to be moved forwards to contact and press the first floating unit to thus lock the first floating unit such that the first floating unit cannot be rotated and to be moved rearwards and separated from the first floating unit to thus release the locked state of the first floating unit, and a drive actuator mounted to the rotation device to move the friction member forwards and rearwards to thus lock the first floating unit and release the locked state of the first floating unit.

Other aspects and preferred implementations of the present disclosure are discussed infra.

It is to be understood that the term “vehicle” or “vehicular” or other similar terms used herein are inclusive of motor vehicles in general, such as passenger automobiles including sport utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative-fuel vehicles (e.g. fuels derived from resources other than petroleum). As referred to herein, a hybrid vehicle is a vehicle that has two or more sources of power, for example a vehicle powered by both gasoline and electricity.

The above and other features of the present disclosure are discussed infra.

### BRIEF DESCRIPTION OF THE DRAWINGS

The above and other features of the present disclosure will now be described in detail with reference to certain example implementations thereof, illustrated in the accompanying drawings which are given hereinbelow by way of illustration only, and thus are not limitative of the present disclosure, and wherein:

FIG. 1 is a view illustrating an example of a cross-section of a hemming portion in the state in which an outer panel and an inner panel are joined to each other;

FIG. 2 is a view illustrating an example of a cross-section of a hemming portion to which welding is performed using a laser welding system according to the present disclosure;

FIG. 3 is a view illustrating an example of the hemming portion of a hood panel to which welding is performed using the laser welding system according to the present disclosure;

FIG. 4 is a view illustrating an example of the welding bead of the hemming portion formed by the laser welding system according to the present disclosure;

FIG. 5 is a perspective view illustrating an example of the laser welding system according to an implementation of the present disclosure;

FIG. 6 is a block diagram illustrating an example of major components of the laser welding system according to the implementation of the present disclosure;

FIG. 7 is a perspective view illustrating an example of the laser welding tool of the laser welding system according to the implementation of the present disclosure;

FIGS. 8 and 9 are a side view and a perspective view illustrating an example of the laser welding tool of the laser welding system according to the implementation of the present disclosure to which a cover is mounted;

FIGS. 10A and 10B are views illustrating an example of the laser welding tool of the laser welding system according to the present disclosure which is rotated by control of force in the rX-axis direction;

FIGS. 11A and 11B are views illustrating an example of the laser welding tool of the laser welding system according to the present disclosure which moves in the Z-axis direction in the floating state;

FIGS. 12A and 12B are exploded perspective views illustrating an example of the construction of the laser welding tool of the laser welding system according to the implementation of the present disclosure;

FIG. 13 is a view illustrating an example of the state in which seam tracking is performed by the guide pin of the laser welding system according to the implementation of the present disclosure; and

FIGS. 14 to 16 are views illustrating an example of operation of the laser welding system according to the implementation of the present disclosure during a welding process.

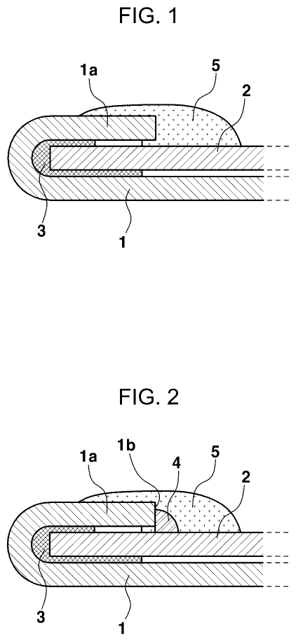

It should be understood that the appended drawings are not necessarily to scale, presenting a somewhat simplified representation of various preferred features illustrative of the basic principles of the present disclosure. The specific design features of the present disclosure as disclosed herein, including, for example, specific dimensions, orientations, locations, and shapes, will be determined in part by the particular intended application and use environment.

In the figures, the reference numbers refer to the same or equivalent parts of the present disclosure throughout the several figures of the drawing.

### DETAILED DESCRIPTION

Implementations of the present disclosure can provide a laser welding system that mitigates the need for a process of pre-curing a hemming seal by enabling welding and fixing of the two panels together, in place of pre-curing of the hemming seal which is performed after application of the hemming seal in order to prevent movement of the panels.

Furthermore, implementations of the present disclosure can provide a laser welding system having a seam tracking structure with a simplified configuration.

Hereinafter, implementations of the present disclosure will be described in detail with reference to the accompanying drawings. Specific structural and functional descriptions of implementations of the present disclosure disclosed herein are only for purposes of illustration of the implementations of the present disclosure. The present disclosure may be embodied in many different forms without departing from the spirit and significant characteristics of the present disclosure. The present disclosure should not be construed as being limited to the implementations stated in this specification, but should be construed as including various alternatives, modifications and equivalents within the spirit and scope of the present disclosure as defined by the appended claims.

It will be understood that, although the terms “first”, “second”, etc. may be used herein to describe various elements, the corresponding elements should not be understood to be limited by these terms, which are used only to distinguish one element from another. For example, within the scope defined by the concept of the present disclosure, a first element may be referred to as a second element, and similarly, a second element may be referred to as a first element.

It should be understood that, when an element is referred to as being “connected to” another element, there may be intervening elements present, or the element may be directly connected to the another element. In contrast, it should be understood that, when an element is referred to as being “directly connected to” another element, there are no intervening element present. Other expressions that explain the relationships between elements, such as “between,” “directly between,” “adjacent to,” or “directly adjacent to,” should be understood in the same way.

Wherever possible, the same reference numbers will be used throughout the drawings to refer to the same or like parts. The terminology used throughout this specification is for the purpose of describing particular implementations only, and is not intended to limit the present disclosure. As used in the disclosure and the appended claims, the singular forms are intended to include the plural forms as well, unless the context clearly indicates otherwise. It will be further understood that the terms “comprises” and/or “comprising”, when used in this specification, specify the presence of stated components, steps, operations, and/or elements, but do not preclude the presence or addition of one or more other components, steps, operations, and/or elements.

FIG. 2 is a view illustrating the cross-section of a hemming portion upon which welding is conducted using a laser welding system according to the present disclosure. In the drawing, reference numeral “4” denotes a bead formed by laser welding.

In the present disclosure, because laser welding is conducted along the seam portion between two panels 1 and 2, the bead 4 is formed along the seam portion between the two panels 1 and 2. The seam portion is the portion between the two panels 1 and 2 upon which welding is conducted, that is, an edge portion of the outer panel and a portion of an inner surface of the inner panel which is welded to the edge portion.

As illustrated in the drawing, a hemming seal 3 is applied between the edge portion of the outer panel 1 and the edge portion of the inner panel 2, a hemming process is conducted to the edge of the outer panel without pre-curing of the hemming seal 3, and laser welding is conducted along the seam portion between both the panels 1 and 2, thus fixing both the panels to each other. In other words, in place of pre-curing the hemming seal 3, welding is conducted on the hemming portion to fix both the panels 1 and 2.

As illustrated in FIG. 2, the welding for the hemming portion is conducted along the boundary portion between both the panels 1 and 2, that is, the portion between the edge portion 1b of the outer panel 1 which is the end of a flange 1a of the outer panel 1 and the inner surface of the inner panel 2. Subsequently, a paint seal 5 is applied so as to cover the welding bead 4. Here, the hemming seal 3 and the paint seal 5 are cured while passing through an oven an after electrodeposition painting process of the vehicle body.

In some implementations of the present disclosure, the welding for the hemming portion may be conducted in place of pre-curing of the hemming seal. Because both the panels 1 and 2 are fixed to each other so as to prevent displacement of both the panels 1 and 2 by virtue of the welding for the hemming portion, the pre-curing of the hemming seal 3 may be omitted, and a jig and an induction heating unit which have been used in a conventional pre-curing process become unnecessary.

In some implementations of the present disclosure, the welding for the hemming portion may be conducted in such a manner as to conduct fillet welding between the edge portion 1b of the outer panel and the surface of the inner panel 2, as illustrated in FIG. 2.

Implementations of the present disclosure can provide a laser welding system which is capable of being used in welding for hemming portion and which is configured to weld both the panels 1 and 2 to fix both the panels to each other after application of the hemming seal 3.

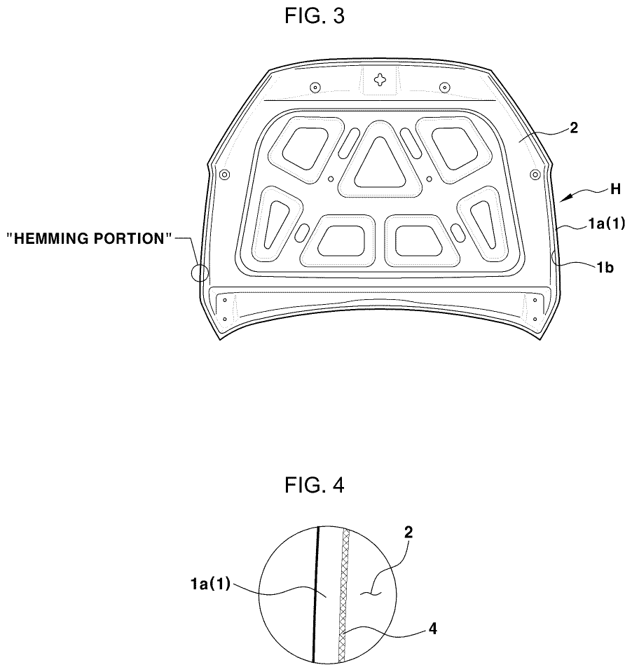

FIG. 3 is a view illustrating a hemming portion of a hood panel which is capable of being welded using the laser welding system according to the present disclosure in which the area in the circle in the drawing indicates the hemming portion at an arbitrary position. FIG. 3 illustrates the edge portion 1b of the outer panel 1, which is the end portion of the flange 1a of the outer panel 1 after the hemming process.

FIG. 4 is a view illustrating the welding bead of the hemming portion formed after welding is conducted using the laser welding system according to the present disclosure. As illustrated in the drawing, welding of the hemming portion involves welding along the boundary portion between the flange 1a of the outer panel 1 and the surface of the inner panel 2, and thus the bead 4 is formed along the welding seam of both the panels 1 and 2.

The laser welding system according to the present disclosure may be used in welding for a hemming portion of a vehicular panel member. Specifically, in the hemming portion, the laser welding system according to the present disclosure may be used to conduct welding along the edge portion which is the flange of one of both the panels to couple both the panels to each other. Here, the vehicular panel member may be the hood panel H in which the outer panel 1 and the inner panel 2 are integrated with each other.

As illustrated in FIG. 2, after the hemming process, the flange 1a of the outer panel 1 is bent onto the inner surface of the inner panel 2, and the edge portion of the outer panel 1 and the inner surface of the inner panel 2 are welded by the laser welding system according to the present disclosure.

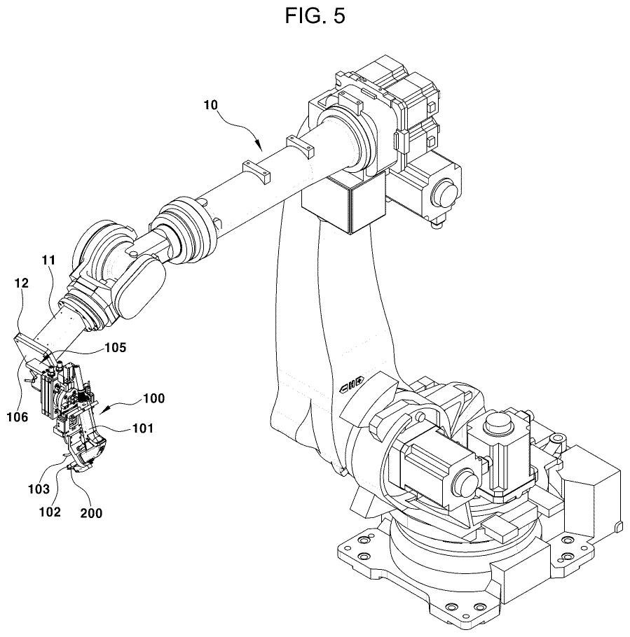

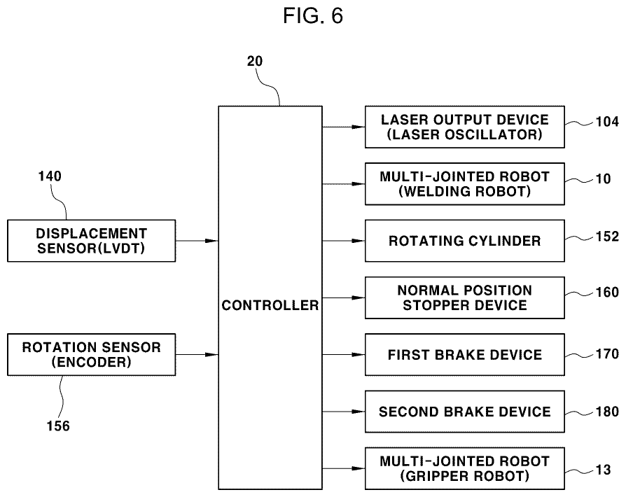

Hereinafter, the construction of the laser welding system will be described in detail. FIG. 5 is a perspective view illustrating the laser welding system according to the present disclosure. FIG. 6 is a block diagram illustrating major components of the laser welding system according to the present disclosure.

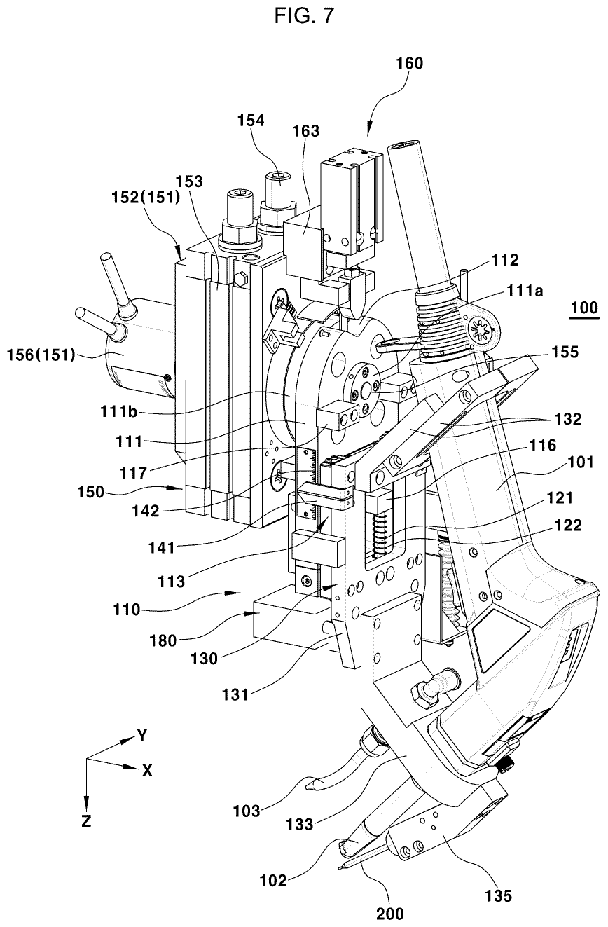

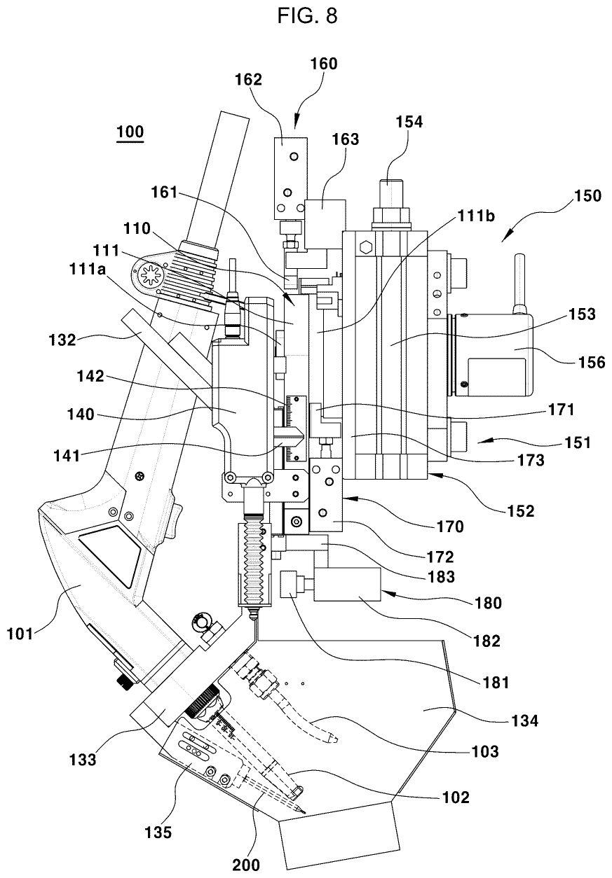

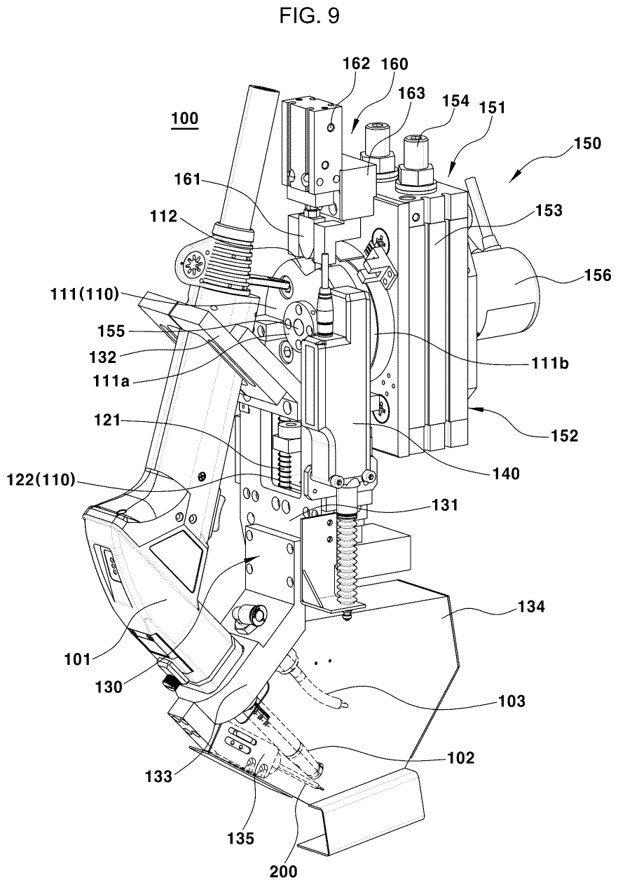

FIG. 7 is a perspective view illustrating a laser welding tool of the laser welding system according to the present disclosure. FIGS. 8 and 9 are a side view and a perspective view of the welding tool of the laser welding system according to the present disclosure with a cover mounted thereon.

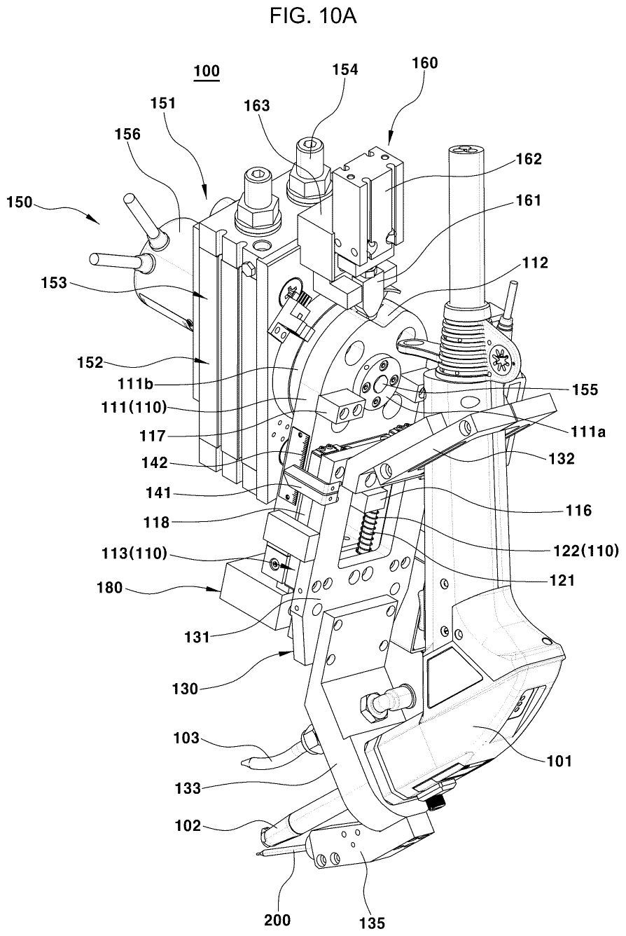

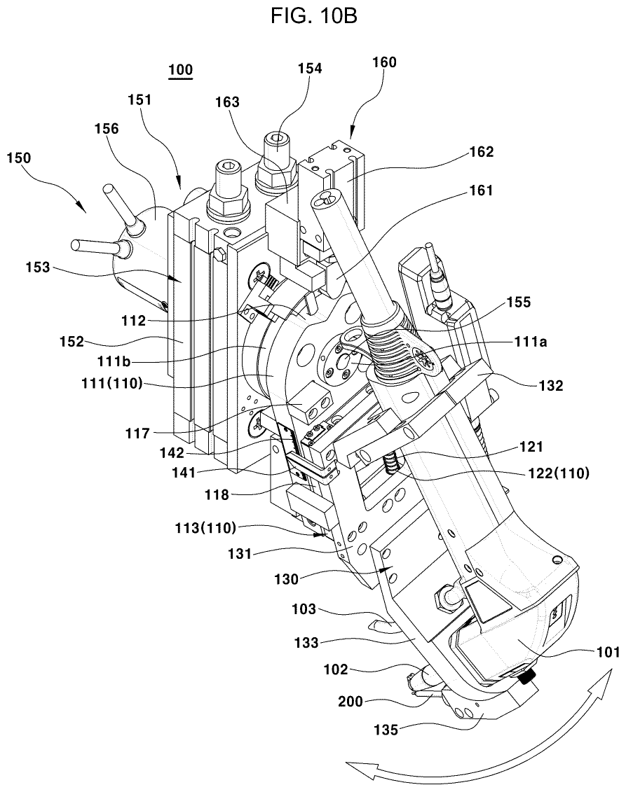

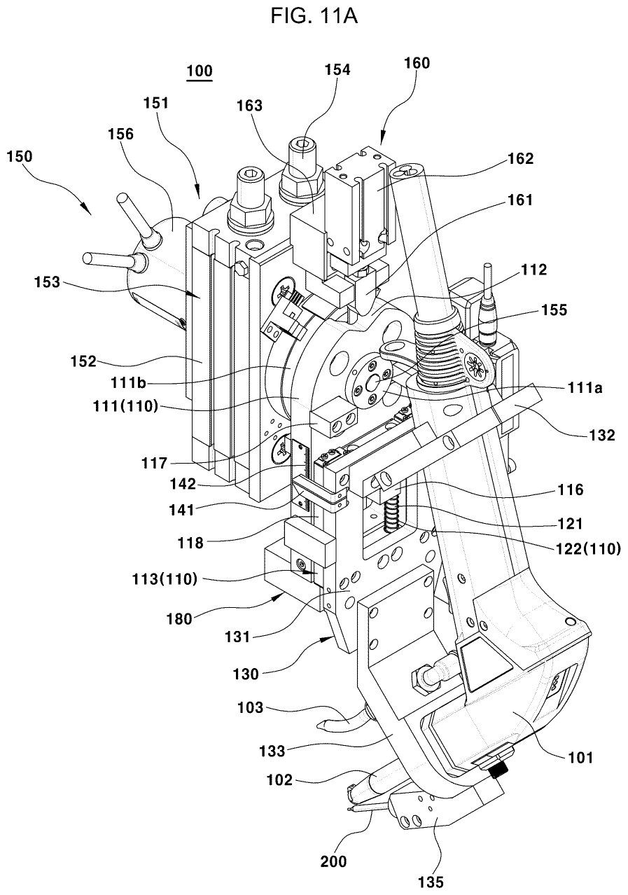

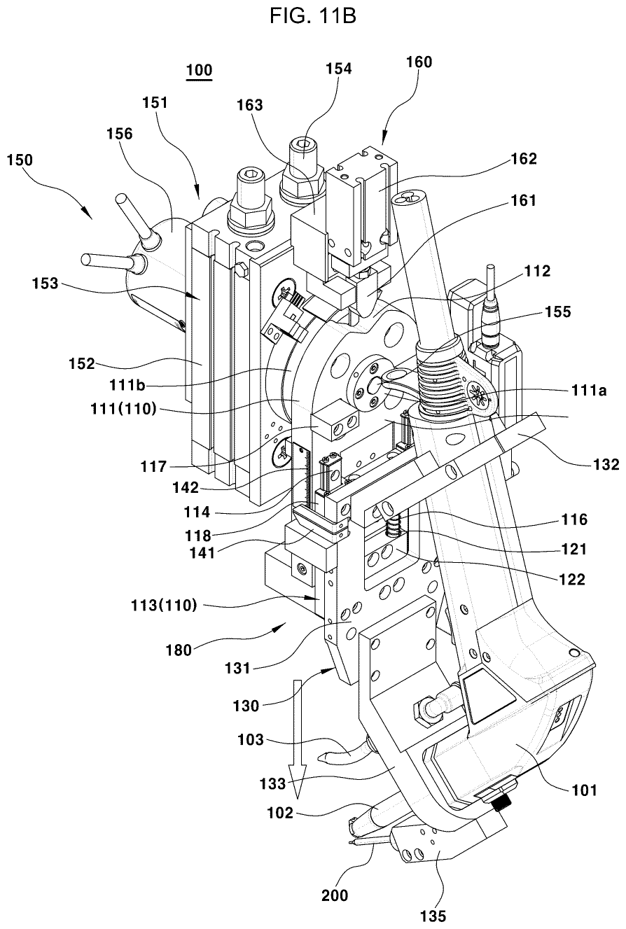

FIGS. 10A and 10B are views illustrating the laser welding tool of the laser welding system according to the present disclosure which is rotated by control of force in an rX-axis direction. FIGS. 11A and 11B are views illustrating the laser welding tool of the laser welding system according to the present disclosure which is moved in a Z-axis direction in a floating state.

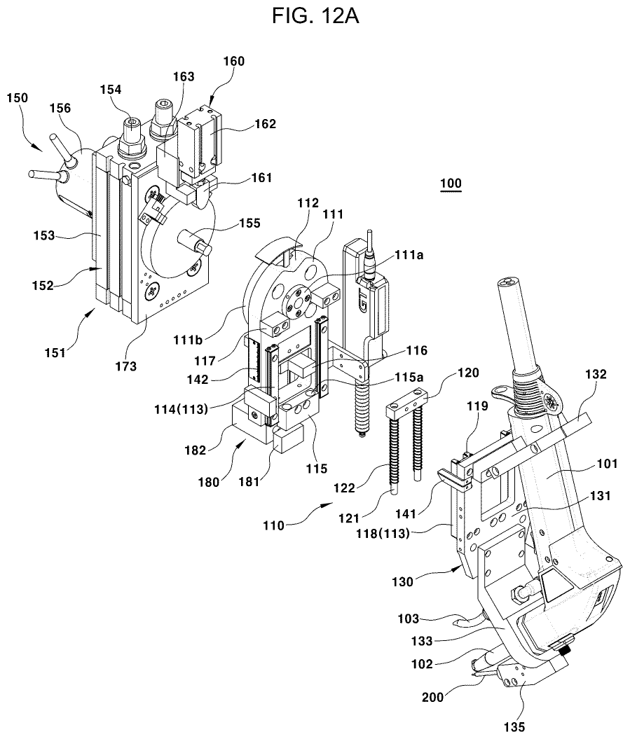

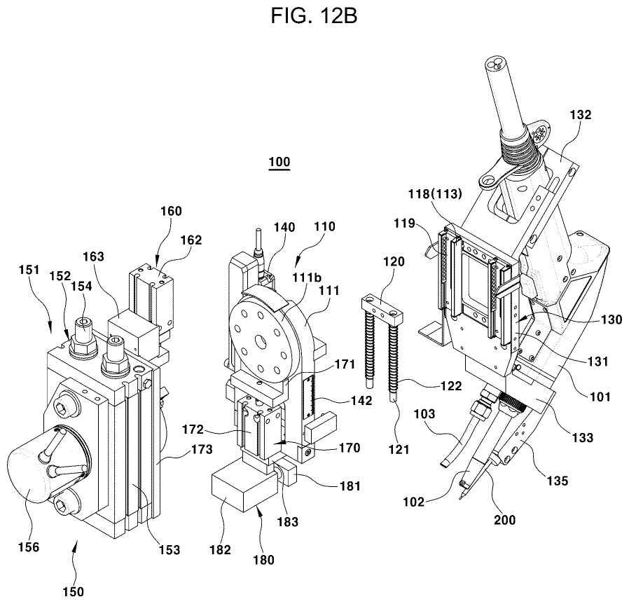

FIGS. 12A and 12B are exploded perspective views illustrating the structure of the laser welding tool of the laser welding system according to implementations of the present disclosure in which the laser welding tool is illustrated in various directions in order to clearly show the structure of the laser welding tool.

The laser welding system according to some implementations of the present disclosure includes a multi-jointed robot 10, the laser welding tool 100 fastened and mounted to the front end of the arm 11 of the multi-jointed robot 10 to conduct welding along a welding seam portion of a base material, and a controller 20 configured to control operation of the entire system.

Here, the laser welding tool 100 includes a welding head 101, a welding tip 102 mounted to the welding head 101, and a seam-tracking guide pin 200 mounted to the laser welding tool 100 in the state of being spaced apart from the welding tip 102. The guide pin 200 guides the welding head 101 along a welding seam portion of the base material.

The multi-jointed robot 10 is a drive apparatus configured to move the laser welding tool 100. The multi-jointed robot is only one example of a drive apparatus configured to move the laser welding tool. In some implementations of the present disclosure, in place of the robot 10, any instrument or device capable of moving the laser welding tool in the state in which the laser welding tool 100 is coupled to the drive apparatus may be applied to the drive apparatus. For example, a Cartesian robot or the like to which a laser welding tool 100 is coupled and which is capable of moving the laser welding tool may be adopted or applied as the drive apparatus.

In some implementations of the present disclosure, based on movement of the laser welding tool 100 by the multi-jointed robot 10 that is the drive apparatus, the guide pin 200 is guided by the welding seam portion of both the panels 1 and 2, which are the welding targets, in the state of contacting the welding seam portion, and thus the laser welding tool 100 tracks the welding seam portion.

The laser welding tool 100 is constructed to conduct laser welding while the welding tip 102 moves along the welding seam portion during tracking by the guide pin 200.

The welding seam portion may be a welding target portion, for example, a welding line or a welding portion of the hood panel to be welded, and the base material may be both the panels 1 and 2 subjected to a hemming process.

In some implementations of the present disclosure, the welding target portion is a portion defining the boundary between both the panels 1 and 2, that is, the edge portion 1b of the end of the flange 1a of the outer panel 1 and the welding target portion of the inner surface of the inner panel 2.

Operation of the multi-jointed robot 10 and the laser welding tool 100 are controlled by the controller 20. The controller 20 may include a controller configured to control operation of the multi-jointed robot 10 and a controller configured to control operation of the laser welding tool 100.

Alternatively, as described later, in the state in which the two hemmed panels (the hood panel), which are workpieces, are loaded to a jig device (not shown), the hemming portion of both the panels (the hood panel) may be welded using the laser welding system according to the present disclosure. In this case, the controller 20 may further include a controller (not shown) configured to control operation of the jig device.

Alternatively, an additional multi-jointed robot 13 (see FIG. 6), which is configured to control the position and angle of both the panels to be appropriate position and angle by moving both the panels which are the workpieces while welding both the panels in the gripped state, may be used.

In this case, the controller 20 may further include an additional controller (not shown) configured to control operation of the additional multi-jointed robot 13 and operation of a gripper (not shown) fastened and mounted to the front end of the arm (not shown) of the multi-jointed robot 13.

Although the controller 20 may be composed of a plurality of controllers which separately control operating components including the multi-jointed robots 10 and 13 and the laser welding tool 100, the jig device, the gripper and the like, the operation of the laser welding system according to the present disclosure may be controlled by a single control component capable of integrally performing a plurality of control functions, in place of the plurality of controllers.

In some implementations of the present disclosure, the plurality of controllers and the single integral control component may collectively be referred to as the controller 20 (see FIG. 6), and the control process of the laser welding system according to the present disclosure which will be described hereinafter may be performed by the controller 20.

In the following description, the term “controller” refers both to the plurality of controllers and the single integrated control component, and the controller controls the entire operation of the laser welding system according to the present disclosure.

In some implementations of the present disclosure, the controller 20 controls a working position of the robot relative to a workpiece through teaching control of the robot 10. Here, because movement of the robot is controlled by the controller 20, the laser welding tool 100 may be moved along the welding target portion of the workpiece, and a working position of the laser welding tool 100 and rotational direction and rotational position (rotational angle) of the laser welding tool 100 may be controlled.

In some implementations of the present disclosure, the laser welding tool 100, which is capable of conducting laser welding, includes a laser output device 104 (e.g., laser oscillator in FIG. 6) configured to supply laser light to the welding tip 102.

In addition, the laser welding tool 100 includes a support device 130 configured to collectively support the welding head 101 and the guide pin 200 mounted thereon, and a floating apparatus configured to cause the support device 130 to enter a floating state in which the support device 130 is movable in an up-and-down direction (in the Z-axis direction) and in a right-and-left direction (in the rX-axis direction) while the guide pin 200 moves along the welding seam portion in the state of contacting the welding seam portion, which is the welding target portion, during a welding process.

Here, the floating apparatus includes a first floating unit 110 and a second floating unit 150. The first floating unit 110 is configured to move the support device 130 in an up-and-down direction to provide force required to press a welding target portion by the guide pin 200 during welding. The second floating unit 150 configured to move the support device 130 in a right-and-left direction to enable the guide pin 200 to provide the welding target portion with opposing force.

In some implementations of the present disclosure, the first floating unit 110 includes a first support frame 111 and an elastic member, e.g., spring 122, and the second floating unit 150 includes a second support frame 105 and a rotation device 151. In the present disclosure, the first floating unit 110 may further include a linear guide 113 for upward and downward movement of the support device 130, which will be described later. For purposes of explanation, an elastic member implemented as a spring 122 is described herein, although implementations are not limited thereto and in general other types of elastic member can be used.

The first floating unit 110 is disposed between the rotation device 151 and the support device 130 of the second floating unit 150 so as to support the welding head 101 and the guide pin 200, which are integrally mounted to the support device 130, in the floating state in which the welding head 101 and the guide pin 200 are movable in an up-and-down direction.

In some implementations of the present disclosure, the spring 122 is disposed between the first support frame 111 and the support device 130 to elastically support the support device 130 with respect to the first support frame 111. Here, the linear guide 113 serves to guide the support device 130 in an up-and-down direction which is elastically moved by means of the spring 122.

The second floating unit 150 may be a device configured to rotate the first floating unit 110 and the support device 130 together with the welding head 101 and the guide pin 200 with respect to the second support frame 105 in a right-and-left direction. To this end, the rotation device 151 mounted to the second support frame 105 may be configured to rotate the first support frame 111 of the first floating unit 110 in a right-and-left direction (in the rX-axis direction).

The second support frame 105 is coupled to the front end of the arm 11 of the multi-jointed robot 10. Specifically, the second support frame 105 includes a fastening plate 106 which is fastened and integrally fixed to a fastening portion 12 that is the front end of the arm 11 of the multi-jointed robot 10, by means of fastening element such as a bolt (see FIG. 5).

Although the detailed construction of the second support frame 105 is not illustrated in FIG. 5, the second support frame 105 may have a construction in which plural plates, including the fastening plate 106, are integrally fixed and combined with each other. Furthermore, a device case and the like (not shown) may be integrally fixed to the upper portion of the second support frame 105.

The device case may be provided therein with devices and components which constitute a pneumatic circuit for control of pneumatic operating components, such as a rotating cylinder 152, a normal position stopper device 160, a first brake device 170, a second brake device 180 and the like, for example, an air supply device, valves configured to control air flow, an air supply pipe and the like. Furthermore, the device case may be provided therein with devices and components associated with laser welding.

In some implementations of the present disclosure, the welding head 101 and the laser output device 104 of the laser welding tool 100 may be a welding head and a laser oscillator which are well known to those skilled in the art. The front end of the welding head 101 is provided with the welding tip 102 extending therefrom.

In some implementations of the present disclosure, the first support frame 111 of the first floating unit 110 is coupled to the rotation device 151 of the second floating unit 150 and is rotated in a right-and-left direction by means of the rotation device 151. The support device 130 is coupled to the first support frame 111 via the spring 122 of the first floating unit 110 so as to be movable in an up-and-down direction.

The support device 130 is elastically supported by the spring 122 with respect to the first support frame 111. Accordingly, the support device 130 is elastically movable by means of the spring 122 with respect to the first support frame 111.

Furthermore, because the welding head 101 and the guide pin 200 are mounted to the support device 130, the welding head 101, the welding tip 102 and the guide pin 200 are elastically movable in an up-and-down direction together with the support device 130 by means of the spring 122 with respect to the first support frame 111.

In some implementations of the present disclosure, the welding head 101 is mounted to the support device 130. The support device 130 may have a construction in which a plurality of members each having a plate shape or a block shape are integrally coupled to and assembled with each other.

Furthermore, because the upper end and the lower end (the front end to which the welding tip is mounted) of the welding head 101 is integrally fixed and coupled to the support device 130, the welding head 101 may be mounted to the support device 130 in a stably supported state.

A tracking head 135 is integrally fixed to the lower end (a support block which will be described later) of the support device 130. The tracking head 135 extends downwards from the lower end of the support device 130. The guide pin 200 is mounted to the tracking head 135.

The first support frame 111 is a component which is integrally coupled and mounted to the rotating shaft 155 of the rotation device 151 and is rotated in a right-and-left direction by rotation of the rotating shaft 155 of the rotation device 151. The rotating shaft 155 of the rotation device 151 is integrally mounted to the rotational center portion 111a provided at the upper portion of the first support frame 111.

Therefore, the first support frame 111 may be rotated in a right-and-left direction about the rotational center portion 111a coupled to the rotating shaft 155 of the rotation device 151. In the following description, the direction in which the first support frame 111 coupled to the rotating shaft 155 of the rotation device 151 is rotated in a right-and-left direction about the rotational center portion 111a is defined as “rX-axis direction” (see FIG. 10B).

The rotational center portion 111a may also be referred to as the swivel axis of the first support frame 111 with respect to the second support frame 105 and the rotation device 151. Furthermore, the rotational center portion 111a may be referred to as the swivel axis about which rotating components, which are rotated in the rX-axis direction, such as the first floating unit 110 including the first support frame 111, and the welding head 101, are swung and rotated.

The support device 130 is a component which is coupled to the first support frame 111 of the first floating unit 110 so as to be slidably movable in an up-and-down direction. The first support frame 111 and the support device 130 may be coupled to each other via the linear guide 113 such as a linear motion (LM) guide.

In some implementations, the linear guide 113 disposed between the first support frame 111 and the support device 130 includes a rail 114 disposed on the front surface of the first support frame 111 so as to extend in an up-and-down direction, and a slide member 118 which is mounted to the rear surface of the support device 130 that faces the front surface of the first support frame 111 and in which a rail groove 119 is formed.

The rail groove 119 in the slide member 118 is formed such that the rail 114 is received and coupled therein. The slide member 118 is disposed on the rear surface of the support device 130 so as to extend in an up-and-down direction, and the rail groove 119 is formed in the longitudinal direction of the slide member 118. The rail groove 119 is also formed so as to extend in an up-and-down direction such that the rail 114 is received and coupled therein.

In some implementations of the present disclosure, the rail 114 may be mounted to each of the right and left sides of the front surface of the first support frame 111, and the slide member 118 may be mounted to each of the right and left sides of the rear surface of the support device 130. Here, the rail 114 and the slide member 118 may be disposed at each of the right and left sides so as to extend in an up-and-down direction.

Accordingly, in the state in which the rail 114 of the first support frame 111 is received and coupled in the rail groove 119 in the slide member 118, the support device 130 may be linearly movable in an up-and-down direction with respect to the first support frame 111 by virtue of the structure in which the rail 114 and the rail groove 119 are coupled to each other.

In some implementations of the present disclosure, an upper block 120 is integrally mounted to the rear surface of the support device 130. The upper block 120 is moved in an up-and-down direction together with the support device 130, like the slide member 118.

The support device 130 may be elastically supported in an up-and-down direction with respect to the first support frame 111. To this end, the spring 122 may be provided between the first support frame 111 and the support device 130, as described above.

The spring 122 is a component capable of elastically supporting the welding head 101 and the guide pin 200 such that the welding head 101 and the guide pin 200 are movable in an up-and-down direction. Accordingly, the floating state of the welding head 101 may be realized by virtue of the spring 122.

The spring 122 is mounted between a lower block 115 of the first support frame 111 and the upper block 120 of the support device 130. Specifically, a guide rod 121 is mounted to the upper block 120 of the support device 130 so as to extend downwards, and a through hole 115a through which the guide rod 121 extends in an up-and-down direction is formed in the lower block 115 which projects forwards from the lower end of the first support frame 111.

The upper end of the guide rod 121 is integrally coupled to the upper block 120 of the support device 130, and the lower end of the guide rod 121 is inserted into the through hole 115a formed in the lower block 115 of the first support frame 111.

Consequently, based on slide movement of the support device 130 with respect to the first support frame 111 in an up-and-down direction, the guide rod 121 is movable in the axis direction in the state of being received in the through hole 115a in the first support frame 111.

The spring 122 may be a coil spring, and may be mounted over the outer circumferential surface of the guide rod 121. Here, the spring 122 is supported at the upper end thereof by the upper block 120 and at the lower end thereof by the lower block 115 of the first support frame 111.

In some implementations of the present disclosure, the guide rod 121 may be installed at each of the right and left sides of the upper block 120, and the through hole 115a may be formed in each of the right and left sides of the lower block 115 of the first support frame 111. The spring 122 may be mounted over each of the right and left guide rods 121.

Because the support device 130 is coupled to the first support frame 111 via the rail 114 and the rail groove 119 so as to be slidably movable in an up-and-down direction and is elastically supported by the spring 122 so as to be movable in an up-and-down direction with respect to the first support frame 111, the force of the spring 122 mounted over the guide rod 121 serves as force to elastically support the support device 130 with respect to the first support frame 111.

In this way, the support device 130 is coupled to and supported by the first support frame 111 in the state of being elastically supported and movable in an up-and-down direction by means of the spring 122, that is, in the floating state. The position and vertical movement of the support device 130 in the floating state with respect to the first support frame 111 may vary according to the tensile force of the spring 122.

In some implementations of the present disclosure, the first support frame 111 may be provided with a lower limit bar 116 which projects forwards. A shock absorber (not shown) may further be fixedly mounted to the upper side of the lower limit bar 116.

The lower limit bar 116 may extend horizontally from the front surface of the first support frame 111. The lower limit bar 116 is disposed under the upper block 120 of the support device 130. The shock absorber mounted to the upper side of the lower limit bar 116 is disposed so as to be spaced apart from the upper block 120.

Based on the support device 130 and the welding head 101 mounted to the support device 130 being lowered to a predetermined minimal height, that is, a limit height, the lower limit bar 116 serves to limit further downward movement of the support device 130 and the welding head 101.

In other words, the lower limit bar 116 serves to limit downward movement of the support device 130 such that the support device 130 cannot be lowered beyond the limit height.

Based on the support device 130 being lowered to the limit height, the upper block 120 of the support device 130 is brought into contact with the shock absorber of the lower limit bar 116. Here, the lower limit bar 116 limits the downward movement of the support device 130 by means of the shock absorber such that the support device 130 cannot be further lowered from the limit height.

The upper end of the first support frame 111 may further be provided on the front surface thereof with an upper limit bar 117 separately from the lower limit bar 116. The upper limit bar 117 may be positioned over the lower limit bar 116 and the linear guide 113.

In some implementations of the present disclosure, the upper limit bar 117 may be mounted at each of the right and left sides of the front surface of the upper end of the first support frame 111. Particularly, the upper limit bar 117 may be mounted so as to be positioned over each of the right and left slide members 118.

The upper limit bar 117 may project forwards from the front surface of the upper end of the first support frame 111. Based on the support device 130 being excessively moved upwards together with the welding head 101, the upper limit bar 117 may be brought into contact with the stopper mounted to the support device 130, that is, each of the right and left slide members 118.

Accordingly, based on the support device 130 being excessively moved upwards with respect to the first support frame 111, the right and left slide members 118, which are the stoppers, are respectively brought into contact with the upper limit bars 117, thus limiting upward movement of the support device 130.

The support device 130 includes a support plate to which the slide member 118 and the upper block 120 are integrally coupled, a bracket 132 mounted to the upper end of the support plate 131, and a support block 133 mounted to the lower end of the support plate 131.

The support block 133 is a component which constitutes the lower end of the support device 130 and to which the lower end of the welding head 101 is coupled so as to be supported thereby. Furthermore, the support block 133 is a portion to which the tracking head 135 with the guide pin 200 mounted thereon, the welding tip 102 and a cross-jet 103 are mounted.

In some implementations of the present disclosure, the lower end of the welding head 101, particularly the front end of the welding head 101 with the welding tip 102 mounted thereon is integrally fixed to support block 133 of the support device 130. Here, the front end of the welding head 101 may extend through the support block 133 and may be coupled thereto.

The welding tip 102 mounted to the front end of the welding head 101 may be disposed so as to extend downwards from the support block 133. The tracking head 135 may be disposed so as to extend downwards from the support block 133.

The upper end of the welding head 101 is integrally fixed to the bracket 132 mounted to the upper end of the support plate 131 of the support device 130. Here, the upper end of the welding head 101 may be coupled and fixed to the bracket 132 in the state of extending through the bracket 132.

In some implementations of the present disclosure, a cover 134 may be mounted to the support device 130 so as to shield and cover the lateral side of the support device 130 (see FIGS. 8 and 9). The cover 134 is a component configured to shield a laser beam to thus prevent the laser beam from being scattered in a lateral direction during welding of a hemming portion.

In some implementations of the present disclosure, in this way, the cover 134 may be disposed at a lateral side of the welding tool 100 so as to block scattering of a laser beam. Therefore, by virtue of provision of the cover 134, the risk associated with the laser beam is mitigated.

In the laser welding system according to the present disclosure, the guide pin 200 mounted to the welding head 101 is disposed such that the front end thereof is spaced apart from the front end of the welding tip 102 by a predetermined distance.

In some implementations of the present disclosure, the tracking head 135 may be mounted to the support block 133 of the support device 130 so as to extend downwards, and the guide pin 200 may be mounted to the tracking head 135.

The guide pin 200 may also be mounted to the tracking head 135 so as to extend downwards. Consequently, both the tracking head 135 and the guide pin 200 may extend downwards from the support block 133. Here, all of the tracking head 135 and the guide pin 200 may be disposed so as to linearly extend downwards.

The tracking head 135 is a component configured to support the guide pin 200 by the support block 133 of the support device 130. The guide pin 200 may be mounted to the tracking head 135 in the state in which the rear end of the guide pin 200 is inserted into the tracking head 135 and is coupled thereto.

In some implementations of the present disclosure, the guide pin 200 may be detachably coupled to the tracking head 135 such that the guide pin 200 can be replaced with a fresh one after use for a predetermined period of time. Here, as the structure of the guide pin 200 capable of being applied to the tracking head 135, any structure may be applied to the present disclosure without limitation as long as the guide pin 200 can be detachably coupled to the tracking head 135 in such a manner that the rear end of the guide pin 200 is inserted into a pin insertion portion (not shown) formed in the tracking head 135.

For example, a threaded coupling structure in which the rear end of the guide pin 200 is threadedly inserted into and coupled to the pin insertion portion of the tracking head 135 may be employed. Alternatively, a structure in which the rear end of the guide pin 200 is forcibly fitted into the pin insertion portion of the tracking head 135, or a structure in which the rear end of the guide pin 200 inserted into the pin insertion portion of the tracking head 135 is fastened by means of a bolt may be employed.

Alternatively, the tracking head 135 may also be provided with a tool, such as, a clamp tool configured to fasten or loosen the guide pin 200. Specifically, a clamp tool capable of fastening and pressing the rear end of the guide pin 200 to fix the rear end to the tracking head 135 or of loosening the fastened rear end to release the rear end after the rear end of the guide pin 200 is inserted into the pin insertion portion of the tracking head 135 may be employed.

In addition, any coupling structure or coupling tool for replacement and detachable attachment of the guide pin 200 may be applied to the tracking head 135 as long as the rear end of the guide pin 200 inserted into the pin insertion portion of the tracking head 135 can be selectively locked or unlocked.

As described above, the front end of the guide pin 2100 is disposed so as to be spaced apart from the front end of the welding tip 102 by a predetermined distance. The guide pin 200 may be positioned in front of the welding tip 102 in a direction of welding process, and may be inclined at a predetermined angle relative to the direction of welding process.

More specifically, based on the welding head 101 moving along the seam portion between both the panels for welding of the hemming portion, the front end of the guide pin 200 and the front end of the welding tip 102 moves along the seam portion while maintaining a predetermined distance between the front end of the guide pin 200 and the front end of the welding tip 102.

While the guide pin 200 and the welding tip 102 move along the seam portion, the front end of the guide pin 200 first moves along a predetermined traveling path in the traveling direction of the welding head 101, and the front end of the welding tip 102 moves to follow the front end of the guide pin 200.

Here, the front end of the guide pin 200 moves along the edge portion 1b of the outer panel 1 constituting the welding seam portion, and the front end of the welding tip 102 follows the front end of the guide pin 200 along the trace in which the guide pin 200 has moved.

As described later, the front end of the guide pin 200 is guided along the edge portion 1b of the outer panel 1 in the state of contacting and catching on the edge portion 1b during welding of the hemming portion. In the case in which the welding tip 102 is mounted to the support block 133 of the support device 130 so as to be spaced apart from the guide pin 200 by a predetermined distance, the welding tip 102 moves along the traveling path of the guide pin 200 in the state of non-contact with the edge portion 1b.

In some implementations of the present disclosure, the support block 133 of the support device 130 may be provided with the cross-jet 103 configured to spray high pressure air. The cross-jet 103 is configured to spray high pressure air, supplied through a tube (not shown) from an air supply (not shown), in a predetermined direction. In other words, the cross-jet 103 is configured to spray high pressure air toward the welding zone including the space around the welding tip 102 and the guide pin 200.

The constructions of the support device and the floating apparatus have heretofore been described. In the following description, the direction in which the support device 130 slidably moves with respect to the first support frame 111 is defined as “Z-axis direction” (see FIG. 11B).

In some implementations of the present disclosure, by virtue of the above-mentioned construction of the floating apparatus, the support device 130 and the welding head 101 are movable in the Z-axis direction, which is an up-and-down direction, with respect to the first support frame 111. Particularly, in the present disclosure, the welding head 101 of the welding tool 100 is movable in an up-and-down direction in the Z-axis direction by means of the first floating unit 110 of the floating apparatus, and may be elastically supported and moved by means of the spring 122 of the first floating unit 110.

In some implementations of the present disclosure, among the components of the laser welding tool 100, the components capable of moving in the Z-axis direction, that is, Z-axis movable components include the support device 130 coupled to the first support frame 111 so as to be slidably movable in an up-and-down direction, the welding head 101 integrally mounted to the support device 130, the welding tip 102 mounted to the welding head 101, the cross-jet 103, the guide pin 200 and the like. Because the first support frame is immovable in the Z-axis direction, the first support frame 111 is a stationary component with regard to the Z-axis direction.

As described above, the welding head 101 of the laser welding tool 100 is supported by the first floating unit 110 so as to be movable in the Z-axis direction (in an up-and-down direction), and is elastically supported by the spring 122 of the first floating unit 110 in the Z-axis direction (in an up-and-down direction). Accordingly, the welding head 101 may be supported by the floating apparatus in the floating state in the Z-axis direction.

In some implementations, the welding head 101 of the laser welding tool 100 may be in the floating state in which the welding head 101 is floated by the elastic force of the spring 122. In this state, the force with which the welding seam portion is pressed by the guide pin of the welding head 101 (the force applied to the edge portion 1b of the outer panel 1) may be controlled by rotational position of the welding head 101 in the rX-axis direction, the distance between the welding head 101 and the base material (the hood panel), the weight of the Z-axis direction movable component including the welding head 101, the tensile force of the spring 122 and the like.

The spring 122 may serve to control (e.g., persistently control) the force with which the welding target portion is pressed by the guide pin 200 while expanding and being compressed due to the weight of the Z-axis direction movable component and the like during a welding process.

The floating apparatus may further include a displacement sensor 140 configured to measure displacement in the Z-axis direction of the Z-axis direction movable component including the welding head 101 in real time. The displacement sensor 140 may be disposed between the first support frame 111 of the first floating unit 110, which is the Z-axis direction stationary component, and the support device 130, which is the Z-axis direction movable component, and may be configured to detect relative displacement in the Z-axis direction of the support device 130 with respect to the first support frame 111.

As the displacement sensor 140, a contact-type displacement sensor or a non-contact-type displacement sensor may be adopted and used. For example, a linear variable displacement transducer (LVDT), which is one of the contact-type displacement sensors, may be used.

The displacement sensor 140 is electrically connected to the controller 20. Accordingly, an electrical signal output from the displacement sensor 140, that is, a signal indicating a displacement may be input to the controller 20. Consequently, the controller 20 may obtain information about the displacement in the Z-axis direction from the signal output from the displacement sensor 140.

Based on a displacement in the Z-axis direction of the welding head 101, which is detected by the displacement sensor 140 being out of a predetermined range, the controller 20 may determine that the guide pin 200 escapes from the seam tracking path, and may perform control to stop operation of the multi-jointed robot 10 and the laser welding system such as the laser welding tool 100.

In FIGS. 7, 8, 10A and 10B, reference numerals “141 and 142” respectively denote a pointer and a scale which allows an operator to check height of the Z-axis direction movable component such as the welding head 101 with the naked eye. The pointer 141 may be fixedly mounted to the support device 130, and the scale 142 may be provided at the first support frame 111 which is the Z-axis direction stationary component.

The rotation device 151, which is configured to swing the support device 130 about the rotating shaft 155, may include a rotating actuator mounted to the second support frame 105 and configured to rotate the first floating unit 110 including the first support frame 111 in the rX-axis direction.

The rotating actuator may cause the guide pin 200 to be brought into close contact with the welding target portion, and may control (e.g., persistently control) a force applied to the welding target portion by the guide pin 200 in the state in which the guide pin 200 is in close contact with the welding target portion during a welding process.

The rotating actuator may be a known rotating cylinder which is driven and rotated by pneumatic pressure or hydraulic pressure. The rotating cylinder is a rotating actuator which is extensively used in a relevant industry, and the construction thereof is well known to those in the art.

There is no particular difference in construction and operating principle between a pneumatic rotating cylinder and a hydraulic rotating cylinder, except for that actuating fluids thereof are air and oil. In the following description, the construction of the rotating cylinder will be briefly described based on a pneumatic rotating cylinder which uses air as an actuating fluid.

The rotating cylinder includes a body 153 integrally fixed to the second support frame 105, a pair of pistons (not shown), and a rotating shaft 155 coupled to the pistons via a rack-pinion structure. The body 153 includes a pair of chambers (not shown) to and from which air as the actuating fluid is supplied and discharged. The pair of chambers in the body 153 are formed so as to be parallel to each other, and each of the pair of chambers has a hermetically closed inner space.

The pair of pistons are respectively mounted in the pair of chambers so as to be movable forwards and backwards in the longitudinal direction of the chambers. Two opposite ends of each of the chambers are respectively provided with ports 154 for introduction and discharge of air. Each of the ports 154 is connected to a tube (not shown).

Although not illustrated in the drawings, the tubes are connected to a valve device configured to control introduction and discharge of air and an air supply configured to supply air. Accordingly, it is possible to control moving direction and moving position of the pair of pistons in the respective chambers by controlling supply and discharge of air to and from the chambers.

The rotating shaft 155 is rotatably mounted in the body 153 between the pair of pistons. The rotating shaft 155 is coupled to the two pistons via rack-pinion structures. To this end, a pinion-shaped teeth portion is formed at the portion of the rotating shaft 155 that is positioned in the body 153, and rack-shaped teeth portions are respectively formed at the pistons.

Accordingly, based on the pistons being moved forwards and rearwards in the state in which the teeth portion of the rotating shaft 155 and the teeth portions of the pistons are engaged with each other in a rack-pinion engagement manner, the rotating shaft 155 is rotated. Here, the pair of pistons are controlled so as to be moved in opposite directions, and a rotational direction and a rotational position of the rotating shaft 155 may be controlled by moving directions and moving positions of the two pistons in respective chambers.

As described above, because the rotating shaft 155 is integrally and rotatably coupled to the rotational center portion 111a, the first support frame 111 is rotated about the rotational center portion 111a while the rotating shaft 155 of the rotation device 151 is rotated.

Although the rotating shaft 155 may be directly coupled to the rotational center portion 111a of the first support frame 111, the rotating shaft 155 may also be coupled to the rotational center portion 111a of the first support frame 111 via an additional member such as a rotating table (not shown).

In some implementations of the present disclosure, operation of the rotating cylinder 152 is controlled by the controller 20. The controller 20 may perform control of force of the rotating cylinder 152 in order to control the laser welding tool 100 in the rX-axis direction (in the rightward-and-leftward rotational direction), particularly rotational directions and rotational positions (rotational angles) of the floating apparatus and the welding head 101 mounted to the floating apparatus.

A proportional control valve may be used as a valve device (not shown) for variable control of pneumatic pressure or hydraulic pressure supplied to the chambers of the rotating cylinder 152. The controller 20 controls force for seam tracking in the rX-axis direction (in the rightward-and-leftward rotational direction) by performing control of force using the proportional control valve.

In some implementations of the present disclosure, the rotation device 151 may further include a rotation sensor configured to detect rotation of the rotating cylinder 152. The rotation sensor is used to detect rotational angle of the first floating unit 110.

The rotation sensor 156 may be an encoder connected to the rotating shaft 155 of the rotating cylinder 152. Specifically, the rotation sensor 156 may be a rotary encoder capable of detecting rotational direction and rotational position (rotational angle) of the rotating shaft 155 as information about rotating state of the rotating cylinder 152.

The rotation sensor 156 may be mounted to the rotating cylinder 152, and may be electrically connected to the controller 20 such that an electrical signal output from the rotation sensor 156 is input to the controller 20. Consequently, the controller 20 is able to obtain information about rotating state such as real time rotational direction and rotational position of the rotating cylinder 152 from the electrical signal output from the rotation sensor 156.

Although the implementation in which the rotation sensor is an encoder has heretofore been described, the implementation is only for illustration, and the present disclosure is not limited thereto. In the present disclosure, any component or device may be adopted and used, in place of the encoder, as long as the component or device is capable of detecting rotational direction and rotational position of the rotating shaft 155 of the rotating cylinder 152. For example, a Hall sensor, a resolver and the like, which are capable of detecting rotating state such as rotational direction and rotational position of a rotating body, may be used.

The information about rotating state of the rotating cylinder 152 indicates information about rotating states of the first support frame 111 connected to the rotating cylinder 152 via the rotating shaft 155 and the first floating unit 110 including the first support frame 111, the support device 130 supported by the first floating unit 110, and the welding head 101 mounted to the support device 130.

In other words, rotational direction and rotational position of the rotating shaft 155 are identical to rotational direction and rotational angle of the first floating unit 110, the support device 130 and the welding head 101. Accordingly, the controller 20 is capable of obtaining information about rotating state in the rX-axis direction of the first floating unit 110, the support device 130 and the welding head 101 via the encoder which is the rotation sensor 156.

In some implementations of the present disclosure, based on the rotational position of the rotating cylinder detected by the rotation sensor (encoder) 156 being out of a predetermined reference range, the controller 20 may determine that the guide pin 200 escapes from the seam tracking path formed along the edge portion 1b and may thus perform control to stop operation of the welding system including the multi-jointed robot 10 and the laser welding tool 100.

In some implementations of the present disclosure, the displacement sensor (LVDT) 140 and the rotation sensor (encoder) 156 may be used to determine whether the guide pin 200 escapes from the seam tracking path. Assuming that the state in which the guide pin 200 moves along the edge portion 1b of the outer panel 1 is referred to as a seam tracking state, the values of detection of the displacement sensor 140 and the rotation sensor 156 are out of the predetermined range based on the guide pin 200 escaping from the edge portion 1b without maintaining the seam tracking state.

Accordingly, based on one of the value of detection of the displacement sensor 140 and the value of detection of the rotation sensor 156 being out of a corresponding predetermined range, the controller 20 may determine that the guide pin 200 escapes from the seam tracking path without moving along the edge portion 1b and may perform control to stop the entire laser welding system including the robot 10 and the laser welding tool 100.

Because the rotating cylinder and the encoder, which is the rotation sensor, are extensively used in industry and constructions thereof are also known to those skilled in the art, further description of the rotating cylinder and the encoder is omitted in the specification.

In some implementations of the present disclosure, the laser welding tool 100 may further include the normal position stopper device 160 configured to lock the welding head 101 to prevent the welding head 101 from being rotated from a predetermined normal reference position (the origin position) in the rX-axis direction (in a rightward-and-leftward rotational direction) or to release the locked state of the welding head 101.

The normal position stopper device 160 may be configured to selectively perform locking and release of the support device 130 supporting the welding head 101 and the first floating unit 110 in order to selectively lock the welding head 101 at the normal reference position in the rX-axis direction or release the locked state of the welding head 101. Here, the locking of the welding head 101, the support device 130 and the first floating unit 110 means that the welding head 101, the support device 130 and the first floating unit 110 are locked so as not to be rotated in the rX-axis direction.

The normal reference position may be the origin (zero) position at which the welding head 101, the support device 130 and the first floating unit 110 are not rotated in any of rightward and leftward directions in the rX-axis direction. The state in which the welding head 101, the support device 130 and the first floating unit 110 are set and locked at the origin position which is the normal reference position means the state in which the welding head 101, the support device 130 and the first floating unit 110 are vertically arranged and locked in an up-and-down direction.

The normal position stopper device 160 includes a stopper 161 configured to lock and constrain the first floating unit 110 to prevent the first floating unit 110 from being rotated relative to the rotation device 151 of the first floating unit 110, and a drive actuator 162 configured to move the stopper 161 forwards and rearwards to lock the first floating unit 110 and release the locked state.

In some implementations of the present disclosure, the normal position stopper device 160 may be configured to enable the stopper 161 to selectively lock the first support frame 111, among the components of the first floating unit 110, or release the locked state.

To this end, a locking groove 112 into which the stopper 161 is inserted is formed in the upper end of the first support frame 111, and the stopper 161 and the drive actuator 162 are disposed over the first support frame 111.

The locking groove 112 in the first support frame 111 is formed at a position of the first support frame 111 such that the stopper 161 can be lowered and inserted into the locking groove 112 based on the first support frame 111 being positioned at the origin position in the rX-axis direction, that is, at the normal reference position.

The drive actuator 162 may be mounted to the stationary component of the rotation device 151, particularly to the body 153 of the rotating cylinder 152 via the bracket 163.

The drive actuator 162 may be a pneumatic cylinder or a hydraulic cylinder. In addition, any of components capable of linearly moving the stopper 161 in a forward-and-rearward direction may be adopted as the drive actuator.

Operation of the drive actuator 162 is controlled by the controller 20. Based on the welding head 101, the support device 130 and the first floating unit 110 being positioned at the normal reference position, the controller 20 may perform control to activate the drive actuator 162 to move the stopper 161 forwards.

Here, based on the stopper 161 being inserted into the locking groove 112 in the first support frame 111, the normal position stopper device 160 locks the entire first floating unit 110 including the first support frame 111 and the support device 130 and the welding head 101 mounted to the first floating unit 110 to prevent they from being rotated in the rX-axis direction.

In some implementations of the present disclosure, the laser welding tool 100 may further include, in addition to the normal position stopper device 160, the first brake device 170 configured to lock the welding head 101 at predetermined rotational position and angle in the rX-axis direction (in a right-and-left direction) or release the locked state.

In order to perform locking and release of the welding head 101, the first brake device 170 may be configured to selectively lock the first support frame 111 of the first floating unit 110 at a predetermined position in the rX-axis direction with respect to the stationary component of the rotation device 151 and to release the locked state.

To this end, the first brake device 170 may be mounted between the body 153 of the rotating cylinder 152 which is a stationary component of the rotation device 151 of the second floating unit 150 and is fixed to the second support frame 105, and the first support frame 111 which is a rotatable component in the rX-axis direction of the first floating unit 110.

Here, the first brake device 170 is configured to lock the first support frame 111 with respect to the body 153 of the rotating cylinder 152 such that the first support frame 111 connected to the rotating shaft 155 of the rotating cylinder 152 cannot be rotated with respect to the body 153 of the rotating cylinder and to release the locked state.

The first brake device 170 may be a frictional braking-type brake device configured to lock the entire first floating unit 110 including the first support frame 111 to prevent rotation thereof, by virtue of frictional force with the first support frame 111 which is generated based on the first brake device 170 contacting and pressing the first support frame 111 of the first floating unit 110.

The frictional braking-type first brake device 170 may be configured to contact and press the outer circumferential surface of a disc 111b integrally coupled to the first support frame 111 and to be separated from the outer circumferential surface of the disc 111b so as to release the pressed state of the disc 111b.

To this end, the first brake device 170 may include a drive actuator 172 and a friction member 171 configured to be moved forwards and rearwards by the drive actuator 172. Based on the friction member 171 being moved forwards by the drive actuator 172, the friction member 171 contacts and presses the disc 111b of the first support frame 111 of the first floating unit 110.

Meanwhile, based on the friction member 171 being moved rearwards by the drive actuator 172, the friction member 171 is separated from the disc 111b of the first support frame 111, thus releasing the pressed state of the disc 111b of the first support frame 111.

Based on the friction member 171 being moved forwards to contact and press the disc 111b of the first support frame 111, by virtue of the frictional force between the friction member 171 and the disc 111b, the first floating unit 110 including the first support frame 111 and the welding head 101 mounted to the first floating unit 110 may be constrained without being rotated in the rX-axis direction.

The drive actuator 172 of the first brake device 170 may be fixed mounted to the body 153 of the rotating cylinder 152 via the bracket 173, and may be configured to move the friction member 171 by a predetermined stroke forwards and rearwards. As described above, the rotational center portion 111a of the first support frame 111 is a portion coupled to the rotating shaft 155 of the rotating cylinder 152.

Based on the friction member 171 being moved forwards toward the disc 111b of the first support frame 111 by means of the drive actuator 172 of the first brake device 170, the friction member 171 contacts and presses the outer circumferential surface of the disc 111b. At this time, by virtue of the frictional force between the friction member 171 and the disc 111b, the entire first floating unit 110 including the first support frame 111 may be locked and constrained without being rotated in the rX-axis direction.

In some implementations of the present disclosure, the laser welding tool 100 may further include a second brake device 180 configured to lock the welding head 101 at a predetermined vertical position in the Z-axis direction and to release the locked state.

In order to lock the welding head 101 at a predetermined vertical position in the Z-axis direction and to release the locked state, the second brake device 180 may be configured to lock the support device 130, to which the welding head 101 is mounted and which is the movable component in the Z-axis direction, at a predetermined position with respect to the first support frame 111, which is the stationary component of the first floating unit 110 in the Z-axis direction, and to release the locked state.

In other words, the second brake device 180 is disposed between the first support frame 111, which is the stationary component of the first floating unit 110 in the Z-axis direction, and the support device 130, which is the movable component in the Z-axis direction. Consequently, the second brake device 180 is configured to lock the support device 130 with respect to the first support frame 111 such that the support device 130 cannot be slidably moved in an up-and-down direction with respect to the first support frame 111 of the first floating unit 110 and to release the locked state.

The second brake device 180 may be a frictional braking-type brake device configured to lock the support device 130 and the welding head 101 while preventing rotation thereof using the frictional force with the support device 130 which is generated by contacting and pressing the support device 130.

The second brake device 180 may include a drive actuator 182 and a friction member 181 configured to be moved forwards and rearwards by means of the drive actuator 182. The friction member 181 contacts and presses the support device 130 based on the friction member 181 being moved forwards by the drive actuator 182, and the friction member 181 is separated from the support device 130 so as to release the pressed state of the support device 130 based on the friction member 181 being moved rearwards by the drive actuator 182.

Based on the friction member 181 being moved forwards to contact and press the support device 130, the support device 130 and the welding head 101 may be constrained without being rotated in an up-and-down direction by the frictional force between the friction member 181 and the support device 130.

Here, the drive actuator 182 is fixedly mounted to the first support frame 111 via a bracket 183 so as to move only the friction member 181 forwards and rearwards by a predetermined stroke.

Based on the friction member 181 being moved forwards toward the support device 130 by the drive actuator 182, the friction member 181 contacts and presses the support device 130. Here, by virtue of the frictional force between the friction member 181 and the support device 130, the support device 130 and the welding head 101 may be locked and constrained without being rotated in the X-axis direction.

The construction of the laser welding system according to the present disclosure has heretofore been described in detail. Hereinafter, operation of the laser welding system according to the present disclosure will be described.

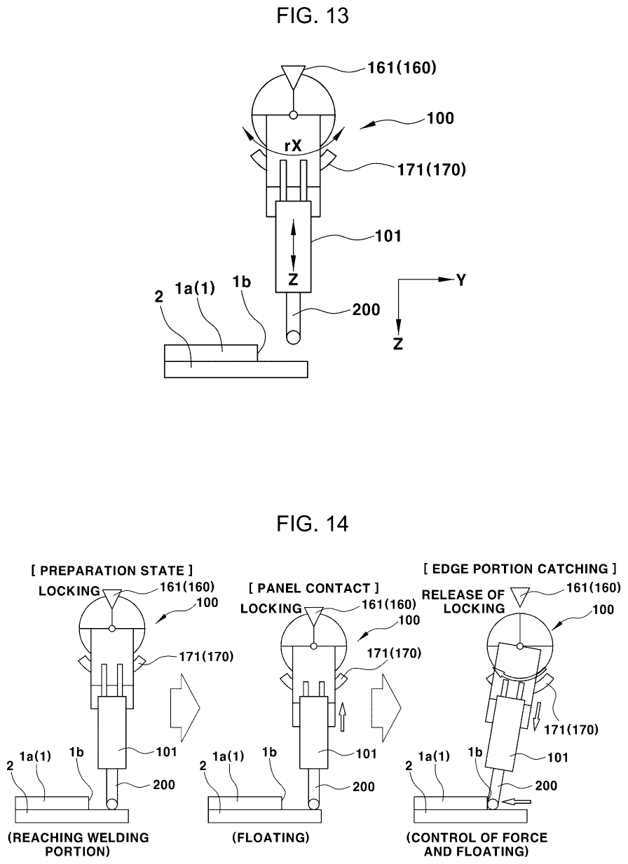

FIG. 13 is a view illustrating seam tracking which is performed by the guide pin of the laser welding system according to the present disclosure. FIGS. 14 to 16 are views operation of the laser welding system according to the present disclosure during a welding process.

As described above, in order to assure improved welding quality, the laser welding system according to the present disclosure is configured to mechanically track the edge portion 1b of the outer panel 1, which is the welding seam portion, by means of the guide pin 200 during welding of the hemming portion.

Assuming that the direction in which the laser welding tool 100 of the laser welding system moves along the edge portion 1b of the outer panel 1 in the welding seam portion of the hemming portion is defined as the X-axis direction, the X-axis direction is a direction perpendicular to the Z-axis direction. Here, a direction perpendicular both to the X-axis direction and to the Z-axis direction is defined as the Y-axis direction (see FIG. 7).

The guide pin 200 and the welding tip 102 mounted to the welding head 101 of the laser welding tool 100 move along the edge portion 1b of the outer panel 1 during welding. Here, the direction in which the guide pin 200 and the welding tip 102 travel may be the X-axis direction.

In the welding, the guide pin 200 moves along the edge portion 1b in the X-axis direction while maintaining the state of catching on the edge portion 1b of the outer panel 1 during seam tracking of the guide pin 200.

Here, the guide pin 200 first moves along the edge portion 1b, and the welding tip 102 follows the guide pin 200. Accordingly, because the welding tip 102 follows the guide pin 200 along the trace in which the guide pin 200 has moved, the welding tip 102 also moves along the edge portion 1b in the X-axis direction.

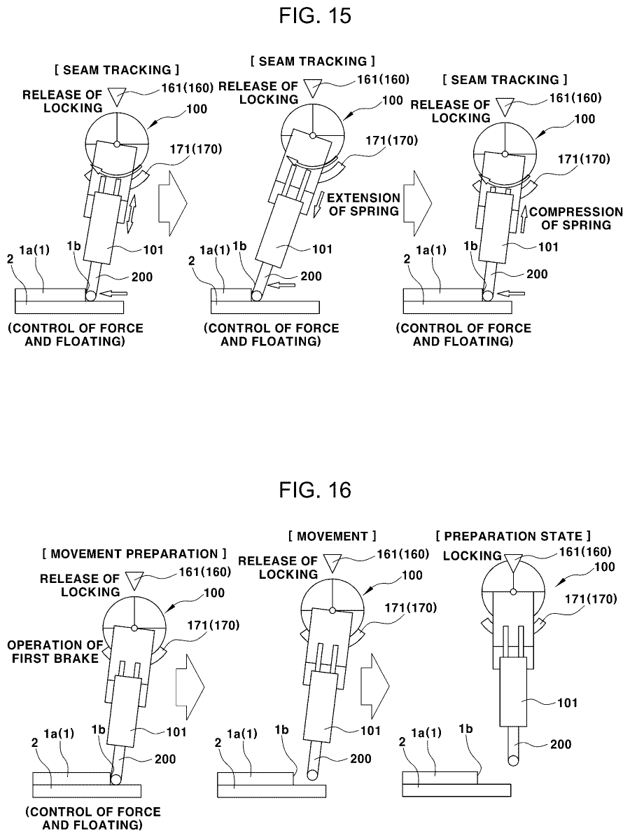

During the seam tracking in which the guide pin 200 moves along the edge portion 1b, by virtue of the force in the Z-axis direction with which the front end of the guide pin 200 presses the panel (the force is denoted by “F_Z” in FIGS. 14 and 15) and the force in the rX-axis direction with which the front end of the guide pin 200 contacts and presses the edge portion 1b (the force is denoted by “F_rX” in FIGS. 14 and 15), the guide pin 200 may move while maintaining the state of catching on the edge portion 1b.

As illustrated in the left figure of FIG. 14, because the first support frame 111 of the laser welding tool 100 is constrained so as not to be rotated by the normal position stopper device 160 in the preparation operation before the welding process, the entire first floating unit 110 including the first support frame 111, the support device 130, and the welding head 101 is set to the normal reference position (the origin position which is not rotated in the rX-axis direction).

In this state, the welding tool 100 moves toward the welding target portion of the hood panel H which is the workpiece, and the welding head 101 moves into the welding portion. Then, the guide pin 200 first contacts the inner surface of the inner panel 2 of the hood panel H (see the mediate figure of FIG. 14).

Here, the first brake device 170 and the second brake device 180 are controlled to release the locked state, and the guide pin 200 is brought into contact with the inner surface of the inner panel 2, with the result that the welding head 101 and the support device 130 reach the floating state in which the welding head 101 and the support device 130 are elastically moved and supported in the Z-axis direction by means of the first floating unit 110.

Subsequently, the locked state by the normal position stopper device 160 is released, and the force in the rX-axis direction is controlled by the rotation device 151. As a result, the front end of the guide pin 200 mounted to the welding head 101, which is in the floating state in the Z-axis direction, is brought into contact with the edge portion 1b of the outer panel 1 and catches on the edge portion 1b in the rX-axis direction (see the right figure of FIG. 14).

In this state, the arm 11 of the robot 10 is operated so as to move the laser welding tool 100 along the hemming welding portion of the hood panel H. Then, the seam tracking by the guide pin 200 is performed while maintaining the state in which the guide pin 200 catches on the edge portion 1b. Here, control of force of the rotation device 151 and the floating state are maintained during the seam tracking (see FIG. 15).

Here, by virtue of the force with which the front end of the guide pin 200 contacts and presses the edge portion 1b, that is, the catching force applied to the edge portion 1b, the guide pin 200 may maintain the seam tracking state without escaping from the welding seam portion between both the panels 1 and 2.

Consequently, the welding tip 102 may move along the hemming welding portion of the hood panel H during the seam tracking by the guide pin 200, and the welding of the welding target portion may be performed by control of on/off of the laser output device 104 during the movement of the welding tip 102.

The control of the force of the rotation device 151 and the floating state are maintained while the welding is performed. Here, if the hood panel H moves away from the welding tip 102, the support device 130 and the welding head 101 are controlled to move toward the hood panel H in the Z-axis direction by the tensile force of the spring 122, and the front end of the guide pin 200 is maintained in the state of catching on the edge portion 1b (see the mediate figure of FIG. 15).

Meanwhile, if the hood panel H moves close to the welding tip 102, the support device 130 and the welding head 101 are controlled to move upwards the direction opposite to the hood panel H in the Z-axis direction. Accordingly, the front end of the guide pin 200 is maintained in the state of catching on the edge portion 1b while pressing the edge portion 1b with appropriate force (see the right figure of FIG. 15).

After the welding, the laser welding system is controlled in the opposite manner to the case in which the welding head moves into the welding portion, and the guide pin 200 is separated from and spaced apart from the hood panel H. After the welding head 101 and the guide pin 200 are separated from the hood panel H, the rotation of the first support frame 111 is constrained again by the normal position stopper device 160. Subsequently, the laser welding tool 100 is moved to the predetermined position through operation of the robot 10, and is positioned in the stand-by state (see FIG. 16).

Meanwhile, in the operation of the laser welding system according to the present disclosure, the hood panel H (see FIG. 3) having been subjected to a hemming process, that is, a workpiece, is loaded to a jig device (not shown), and the hemming portion of the hood panel may be welded by the laser welding system. Here, the operation of the jig device may be controlled by the controller 20.

Alternatively, an additional multi-jointed robot 13 (see FIG. 6) may be used in such a way that the hood panel having been subjected to the hemming process, that is the workpiece H (see FIG. 3), is gripped by a gripper (not shown) and is moved together with the gripper so as to have determined welding position, angle and direction during the welding process.

In this case, the gripper capable of gripping the hood panel having been subjected to the hemming process is fastened and mounted to the front end of the arm of the multi-jointed robot 13. The gripper may be a gripper equipped with a plurality of vacuum cups (not shown) capable of sucking the hood panel by vacuum pressure. The heights and rotation of the vacuum cups may be controlled according to the shapes of the hood panels of various vehicle models.

Furthermore, the gripper may be a gripper further equipped with a plurality of clamps (not shown) capable of clamping the hood panel. For example, the gripper may include a plurality of vacuum cups and two clamps.

In the above-mentioned construction, the hood panel may be clamped in such a way that the hood panel H (see FIG. 3) is sucked and held to the plurality of vacuum cups and then two opposite ends of the hood panel, that is, one end of the hood panel and the opposite end of the hood panel are simultaneously clamped by the two clamps. Therefore, it is possible to clamp hood panels having various sizes.

The multi-jointed robot 13 controls the grippers with the hood panel sucked and held thereto to be moved so as to control the position of the hood panel and controls the angle and direction of the grippers such that the hood panel has a posture suitable for welding. The operation of the multi-jointed robot 13 and the operation of the gripper may be controlled by the controller 20.

In some implementations of the present disclosure, the robot 10 equipped with the laser welding tool 100 and the robot 13 equipped with the grippers are controlled by the controller 20. Here, the operations of both the robots 10 and 13 may be controlled by a single controller 20 configured to perform an integrated function, or may be respectively controlled by separate controllers.

In some implementations of the present disclosure, the controller 20 may be set and programmed so as to perform control for synchronization between both the robots 10 and 13. By virtue of the controlled synchronization between both the robots, the posture, such as position, angle and direction, of the hood panel H and the moving speed and motion speed of the hood panel H may be controlled according to the position, posture and speed of the workpiece suitable for the welding, and the position relative to the hood panel, the posture for welding, such as angle and direction, moving speed, motion speed, and welding speed of the laser welding tool 100 may also be controlled according to the position, the posture and the speed of the moving hood panel suitable for welding of the hemming portion of the hood panel.

Accordingly, the welding may be continuously performed in order of a lateral surface, a front surface, a lateral surface and the like of the hemming portion of the hood panel. Furthermore, because positions, postures, speeds and the like of the laser welding tool and the workpiece (the hood panel) are simultaneously controlled using the robot equipped with grippers, it is possible to continuously perform an accurate and stable process and to thus achieve improved welding quality and process optimization.

Furthermore, it is possible to prevent contamination caused by residual electrodeposition liquid remaining on the hemming portion of the hood panel and to control the position of the hood panel to be positioned at the normal position suitable for welding using the robot in order to easily assure improved welding quality. In addition, it is possible to efficiently prevent deformation of the hemming portion which would otherwise occur in a painting process before an oven process and to deal with various vehicle models using the grippers.

As is apparent from the above description, in the laser welding system according to the present disclosure, because the system uses the guide pin for tracking, it is possible to reduce costs of apparatus and equipment, labor cost and manufacturing cost, compared to a conventional laser welding system equipped with a vision-type seam tracking device or the like. In addition, it is possible to assure improved welding quality by a seam tracking technique using the guide pin.

Furthermore, because the welding device, which is moved and controlled by the multi-jointed robot, welds and fixes two hood panels after a hemming process, compared to a conventional method in which hemming seal is preliminarily cured and finally cured in a printing process, it is possible to reduce or prevent post-deformation of the hemming portion, to further improve merchantability of the appearance of the hemming portion, and to solve problems caused by residual electrodeposition liquid and bubbles in seal.

The present disclosure has been described in detail with reference to example implementations thereof. However, it will be appreciated by those skilled in the art that changes may be made in these implementations without departing from the principles and spirit of the present disclosure, the scope of which is defined in the appended claims and their equivalents.

What is claimed is:

1. A laser welding tool comprising:
a welding head;
a welding tip mounted to the welding head;
a guide pin disposed so as to be spaced apart from the welding tip;
a support device that supports the welding head and the guide pin; and
a floating apparatus connected to the support device and configured to allow the welding head and the guide pin on the support device to move in a floating state, relative to the floating apparatus, along an up-and-down direction and along a right-and-left direction while the guide pin is in a state of contacting a welding target portion during welding.

2. The laser welding tool of claim 1, wherein the welding tip is configured to follow behind the guide pin along the welding target portion while the guide pin moves in the floating state of the support device.

3. The laser welding tool of claim 1, wherein:
the welding target portion includes an edge portion of an end of a first panel and a surface portion of a second panel, and
a front end of the guide pin is guided along the edge portion by a catching force applied to the edge portion while maintaining a state of contacting and pressing the edge portion of the first panel.

4. The laser welding tool of claim 1, wherein the floating apparatus comprises:
a first floating unit configured to move the support device in the up-and-down direction while providing a force for the guide pin to press against the welding target portion during the welding; and
a second floating unit configured to move the support device in the right-and-left direction to apply an opposing force to the welding target portion during the welding.

5. The laser welding tool of claim 4, wherein the first floating unit comprises:
a first support frame coupled to the second floating unit; and
an elastic member disposed between the first support frame and the support device and configured to elastically support the support device in the up-and-down direction.

6. The laser welding tool of claim 5, wherein the first floating unit further comprises a linear guide disposed between the first support frame and the support device and configured to guide the support device, which is elastically moved by the elastic member, in the up-and-down direction.

7. The laser welding tool of claim 4, wherein the second floating unit comprises:
a second support frame; and
a rotation device disposed between the second support frame and the first floating unit and configured to rotate the first floating unit along the right-and-left direction with respect to the second support frame during the welding, and configured to move the guide pin into close contact with the welding target portion and to provide the welding target portion with the opposing force during the welding.

8. The laser welding tool of claim 7, wherein the rotation device comprises a rotating actuator coupled to the second support frame, a rotating shaft of the rotating actuator being coupled to the first floating unit to swingably rotate the first floating unit in the right-and-left direction.

9. The laser welding tool of claim 8, wherein the rotating actuator comprises a pneumatic rotating cylinder or a hydraulic rotating cylinder.

10. A laser welding system comprising:
a laser welding tool comprising a welding head, a welding tip mounted to the welding head, a guide pin disposed so as to be spaced apart from the welding tip, a support device that supports the welding head and the guide pin, and a floating apparatus connected to the support device and configured to allow the welding head and the guide pin on the support device to move in a floating state, relative to the floating apparatus, along an up-and-down direction and along a right-and-left direction while the guide pin is in a state of contacting a welding target portion during welding;
a drive device coupled to and configured to move the laser welding tool; and
a controller configured to control an operation of the drive device and the laser welding tool,
wherein the drive device is configured to move the laser welding tool during welding so that the guide pin, which is supported in the floating state together with the welding head by the floating apparatus, is guided along and tracks the welding target portion in a state of contacting the welding target portion.

11. The laser welding system of claim 10, wherein a position and a posture of the laser welding tool are controlled by the operation of the drive device and the laser welding tool which are controlled by the controller,
wherein the welding tip is configured to follow behind the guide pin along the welding target portion while the guide pin moves along the welding target portion.

12. The laser welding system of claim 10, wherein the floating apparatus comprises:
a first floating unit configured to move the support device in the up-and-down direction while providing a force for the guide pin to press against the welding target portion during the welding; and
a second floating unit configured to move the support device in the right-and-left direction to apply an opposing force to the welding target portion during the welding.

13. The laser welding system of claim 12, wherein the first floating unit comprises:
a first support frame coupled to the second floating unit, and
an elastic member disposed between the first support frame and the support device and configured to elastically support the support device in the up-and-down direction.

14. The laser welding tool of claim 13, wherein the first floating unit further comprises a linear guide disposed between the first support frame and the support device and configured to guide the support device, which is elastically moved by the elastic member, in the up-and-down direction.

15. The laser welding system of claim 13, wherein the first support frame is provided with an upper limit bar, and the support device is provided with a stopper member, and
wherein the upper limit bar limits upward movement of the support device by contact with the stopper member based on the support device being moved upwards to a limit height.

16. The laser welding system of claim 13, wherein:
the support device is provided with an upper block,
the first support frame is provided with a lower block having a through hole,
the upper block is provided with a guide rod which extends downwards and is configured to be inserted into the through hole in the lower block,
the guide rod is configured to move in an axial direction in a state of being inserted into the through hole while the support device moves in the up-and-down direction with respect to the first support frame, and
the elastic member is mounted to the guide rod between the upper block and the lower block.

17. The laser welding system of claim 13, wherein:
the first floating unit further comprises a displacement sensor disposed between the first support frame and the support device and configured to detect relative displacement of the support device with respect to the first support frame; and
the controller is configured to determine that the guide pin escapes from the welding target portion and perform control to stop the operation of the drive device and the laser welding tool, based on a displacement value detected by the displacement sensor being outside of a displacement range.

18. The laser welding system of claim 13, wherein the laser welding tool further comprises a second brake device controlled by the controller to lock the welding head in a first locked state at a first position in the up-and-down direction, and to release the first locked state of the welding head, and
wherein the second brake device comprises:
a friction member configured to be moved forwards to contact and press the support device to thus lock the support device in a second locked state in which the support device cannot be moved in the up-and-down direction and to be moved rearwards to be separated from the support device to thus release the second locked state of the support device; and
a drive actuator mounted to the first support frame and configured to move the friction member forwards and rearwards to thus lock the support device in the second locked state and to release the second locked state of the support device.

19. The laser welding system of claim 12, wherein the second floating unit comprises:
a second support frame; and
a rotation device disposed between the second support frame and the first floating unit and configured to rotate the first floating unit along the right-and-left direction with respect to the second support frame such that the guide pin is brought into close contact with the welding target portion and provides an opposing force to the welding target portion.

20. The laser welding system of claim 19, wherein:
the rotation device comprises a rotating actuator coupled to the second support frame, a rotating shaft of the rotating actuator being coupled to the first floating unit to swingably rotate the first floating unit in the right-and-left direction; and
the controller is configured to perform control of a force of the rotating actuator and control rotational directions and rotational positions of the support device and the welding head mounted to the support device.
